(19) United States
(12) Patent Application Publication
(10) Pub. No.: US 2012/0013552 A1
(43) Pub. Date: Jan. 19, 2012

(54) TOUCH-SENSITIVE DEVICE AND TOUCH-BASED CONTROL METHOD FOR SCREEN BRIGHTNESS THEREOF

(75) Inventor: Won Ick AHN, Yongin-si (KR)

(73) Assignee: SAMSUNG ELECTRONICS CO. LTD., Suwon-si (KR)

(21) Appl. No.: 13/098,634

(22) Filed: May 2, 2011

(30) Foreign Application Priority Data
Jul. 15, 2010 (KR) 10-2010-0068338

(51) Int. Cl. G06F 3/041

(52) U.S. Cl. 345/173

(57) ABSTRACT

A touch-sensitive device and a related control method are provided to allow the control of a predefined function (e.g., screen brightness, volume, vibration) in response to a touch-based user gesture input on a state information display region such as an indicator region. In a method for controlling the screen brightness of the device, a screen is displayed separating the state information display region and a normal display region. When receiving the user gesture scrolled along the state information display region, a control unit of the device adjusts the predefined function in response to the received user gesture.

### PRIORITY

This application claims the benefit under 35 U.S.C. §119(a) of a Korean patent application filed on Jul. 15, 2010 in the Korean Intellectual Property Office and assigned Serial No. 10-2010-0068338, the entire disclosure of which is hereby incorporated by reference.

### BACKGROUND OF THE INVENTION

1. Field of the Invention

The present invention relates to a touch-sensitive electronic device. More particularly, the present invention relates to a touch-sensitive device having a touch-based input interface and a method for controlling the screen brightness of the device in response to a touch gesture input on a state information display region of the device.

2. Description of the Related Art

With a remarkable growth of related technologies, a great variety of mobile devices are becoming increasingly popular. Particularly, mobile devices today outgrow their respective traditional fields and approach a mobile convergence stage. In the case of mobile handsets for example, in addition to normal communication functions such as a voice call and a Short Message Service (SMS), various essential or optional functions are widely used such as a portable broadcasting (e.g., Digital Multimedia Broadcasting (DMB) or Digital Video Broadcasting (DVB)), a digital music play (e.g., MPEG audio layer-3 (MP3)), a digital camera, a wireless Internet, a dictionary, and so forth.

A touch-sensitive device which has a touch screen capable of performing both as a display unit and as an input unit steadily arouses customers' interest. Such a touch-sensitive device adopts in general a full touch screen type and also offers a touch-based input interface.

The current trend regarding a touch-sensitive device is towards innovative design and convenient User Interface (UI). In particular, there is a growing tendency to provide user-friendly UI environments for a touch-sensitive device. To meet such tendency, new functions and approaches to improve user's convenience are continuously developed and introduced in the art. Therefore, a need exists for an improved user-friendly UI environment for a touch-sensitive device and a method for controlling the touch-sensitive device.

### SUMMARY OF THE INVENTION

An aspect of the present invention is to address at least the above-mentioned problems and/or disadvantages and to provide at least the advantages described below. Accordingly, an aspect of the present invention is to provide a new additive function for a user's convenience in a touch-sensitive device.

Another aspect of the present invention is to provide a touch-sensitive device and related control method allowing the control of a predefined function (e.g., screen brightness, audio volume, vibration) in response to a user gesture input on a state information display region of the device while a current execution screen is maintained.

Still another aspect of the present invention is to realize user interface environments usually allowing the control of the predefined function of a display unit in response to a touch-based user gesture input on a state information display region for displaying state information about a touch-sensitive device.

Yet another aspect of the present invention is to provide a touch-sensitive device and related control method allowing the screen brightness of a display unit to be quickly adjusted depending on a touch-based user gesture in a given direction on a state information display region allotted as a scroll region for the control of the predefined function.

Further another aspect of the present invention is to improve usability and convenience of a touch-sensitive device by realizing an intuitive interface for adjusting the predefined function of a touch-sensitive device.

In accordance with an aspect of the present invention, a method for controlling the screen brightness of a touch-sensitive device is provided. The method includes displaying a screen separating a state information display region and a normal display region, receiving a touch-based user gesture scrolled along the state information display region, and adjusting the screen brightness in response to the received user gesture.

In accordance with another aspect of the present invention, a touch-sensitive device is provided. The device includes: a display unit configured to display a screen including a state information display region and to receive a touch-based user gesture scrolled along the state information display region, and a control unit configured to receive the user gesture from the display unit and to adjust a screen brightness of the display unit in response to the received user gesture.

In accordance with still another aspect of the present invention, a method for controlling a particular function of a touch-sensitive device is provided. The method includes: displaying a screen having a state information display region, receiving a touch-based user gesture scrolled along the state information display region, and adjusting the particular function in response to the received user gesture.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram schematically illustrating the configuration of a touch-sensitive device in accordance with an exemplary embodiment of the present invention.

FIGS. 2 and 3 are example views illustrating various representations on a display unit of a touch-sensitive device in accordance with exemplary embodiments of the present invention.

FIGS. 4 and 5 are flow diagrams illustrating a method for controlling the screen brightness of a touch-sensitive device in accordance with exemplary embodiments of the present invention.

FIGS. 6 to 11 are example views illustrating a process of controlling the screen brightness through an indicator region of a touch-sensitive device in accordance with exemplary embodiments of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the present invention by the claims and their equivalents. It includes various specific details to assist in that understanding but these are to be regarded as merely exemplary. Accordingly, those of ordinary skill in the art will recognize that various changes and modifications of the exemplary embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

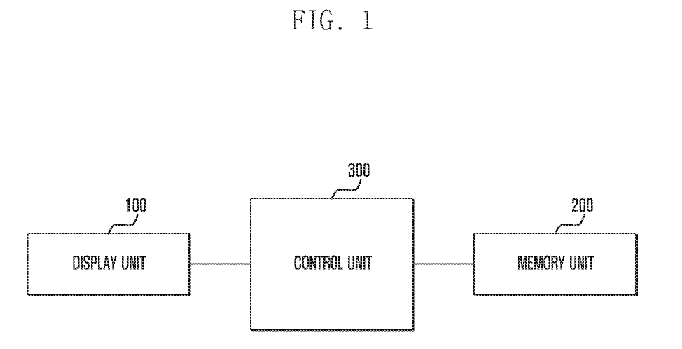

FIGS. 1 through 11, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

The present invention relates to an apparatus and method for allowing an emotional and intuitive control of the screen brightness of a display unit in a touch-sensitive device having a touch-based input interface. In exemplary embodiments of this invention, the screen brightness may be quickly and intuitively adjusted in response to a touch-based user gesture on a state information display region allotted for displaying state information about a touch-sensitive device. Particularly, in exemplary embodiments of this invention, the screen brightness may be increased or decreased depending on the direction of a user gesture on a state information display region, which is a part of an execution screen, without changing a current execution screen displayed in a display unit, namely without entering certain menu pages for setting the screen brightness. In other words, an execution screen is divided into a state information display region (e.g., an indicator region) and an execution information display region, and the screen brightness may be adjusted depending on a user gesture scroll in a right or left direction on the state information display region.

According to this invention, the screen brightness may be usually and quickly adjusted in response to a user gesture input on a state information display region while a display unit maintains a current execution screen. Conventional technique may require entering a specific menu mode for setting the screen brightness if a user desires to adjust the screen brightness while a certain application is executed. Additionally, the adjusted screen brightness may be applied to the current application only. Contrary to that, the present invention requires no screen change, i.e., no entrance to any menu mode, since a state information display region is used to adjust the screen brightness. Furthermore, the adjusted screen brightness is applied to all applications and not limited to the current application.

In exemplary embodiments of this invention, a state information display region refers to a specific region allotted to a part of a display unit in order to display any state information about a touch-sensitive device or a current application. Such state information may be represented as at least one of a static image, a dynamic image and text in a state information display region. This will be described in detail later.

Now, a touch-sensitive device and related control method according to some exemplary embodiments of this invention will be discussed with reference to FIGS. 1 to 11. The following embodiments are, however, exemplary only and not to be considered as a limitation of the present invention. As will be understood by those skilled in the art, any variations may be also possible.

FIG. 1 is a block diagram schematically illustrating the configuration of a touch-sensitive device according to an exemplary embodiment of the present invention.

Referring to FIG. 1, the touch-sensitive device includes a display unit 100, a memory unit 200, and a control unit 300. In addition, the touch-sensitive device may further include a Radio Frequency (RF) unit for performing a wireless communication function, an audio processing unit having a microphone and a speaker, a digital broadcasting module for receiving and outputting digital broadcasting such as Digital Multimedia Broadcasting (DMB) or Digital Video Broadcasting (DVB), a camera module for taking photos and videos, a Bluetooth communication module, an Internet communication module, a touch pad for a touch-based input, a traditional input unit based on a mechanical key input, a light emitting unit for regulating the screen brightness depending on the brightness level of the display unit 100 under the control of the control unit 300, and the like. Since these elements are well known in the art, related illustration and description will be omitted herein.

The display unit 100 displays various execution screens of applications supported in the touch-sensitive device. For instance, many execution screens associated with several essential or optional functions such as SMS, e-mail, Internet, multimedia, search, communication, e-book, taking photo/video, image viewer, watching TV (e.g., DMB or DVB), playing music (e.g., MP3), widget, memo, game, etc., may be provided. The display unit 100 may be formed of LCD (liquid crystal display) or any other equivalent such as Organic Light Emitting Diodes (OLED) or Active Matrix OLED (AMOLED). The display unit 100 may represent a screen view in a widthwise mode (i.e., a landscape mode) or in a lengthwise mode (i.e., a portrait mode), and this mode can depend on a positional orientation of the touch-sensitive device.

In some exemplary embodiments of this invention, the display unit 100 has a touch-based input interface. For instance, the display unit 100 supports a touch-based user gesture input by creating an input signal based on a user gesture and sending it to the control unit 300. Additionally, the display unit 100 in some exemplary embodiments separates an execution information display region for displaying an execution screen and a state information display region (e.g., an indicator region) for displaying state information about a touch-sensitive device. Particularly, the screen brightness of the display unit 100 can be adjusted in response to a touch-based user gesture input on the state information display region. A related description will be given below.

The memory unit 200 stores a variety of programs and related data that are executed and processed in the touch-sensitive device, and may be composed of at least one of volatile memory and nonvolatile memory. For instance, the memory unit 200 may store continuously or temporarily the operating system of the touch-sensitive device, programs and data related to a display control of the display unit 100, programs and data related to an input control through the display unit 100, programs and data related to a screen brightness control through the state information display region (e.g., the indicator region), and the like. Also, the memory unit 200 may store various setting information in connection with a screen brightness control. For instance, the memory unit 200 may store a type of adjusting the screen brightness through the state information display region.

The control unit 300 controls all operations of the touch-sensitive device. Particularly, the control unit 300 controls specific operations related to a screen brightness adjustment. For instance, when a touch-based user gesture is input on the state information display region (e.g., the indicator region) of the display unit 100, the control unit 300 may increase or decrease the screen brightness of the display unit 100 according to a scroll direction of the user gesture.

The control unit 300 may control the screen brightness while maintaining the execution screen displayed in the display unit 100. In addition, when receiving a user gesture input on the state information display region, the control unit 300 may determine whether the user gesture is for adjusting the screen brightness or for displaying a sub-menu and then control a screen brightness adjustment or a sub-menu display accordingly. Furthermore, the control unit 300 may change or maintain the current screen brightness according to setting information when a user gesture is input to adjust the screen brightness, and then increase or decrease the screen brightness in response to a scroll of the user gesture. A related description will be given below.

Besides, the control unit 300 performs various control operations related to normal functions of the touch-sensitive device. For instance, the control unit 300 may control the execution of any application and a related data display. Also, the control unit 300 may receive an input signal based on various input types (e.g., a swing input, a drag input, a flick input, a tap input, a touch input) supported by a touch-based input interface and then control a particular function in response to a received input signal. And the control unit 300 may display the execution information display region only without the state information display region (e.g., the indicator region), depending on the type of the current application.

Meanwhile, the touch-sensitive device of this invention may be applied to any types of mobile device having a touch-based input interface, including a bar type, a folder type, a slide type, a swing type, a flip type, etc. Additionally, the touch-sensitive device of this invention may include any of communication devices, multimedia players and their application equipment. For instance, the touch-sensitive device may include various mobile communication terminals based on various communication protocols, a Portable Multimedia Player (PMP), a digital broadcasting player, a Personal Digital Assistant (PDA), a music player (e.g., an MP3 player), a portable game console, a smart phone, etc.

Additionally, the method for controlling the screen brightness in response to a touch-based user gesture on the state information display region in this invention may be applied to any other devices such as a TV, a Large Format Display (LFD), a Digital Signage (DS), a media pole, a personal computer, a notebook, etc.

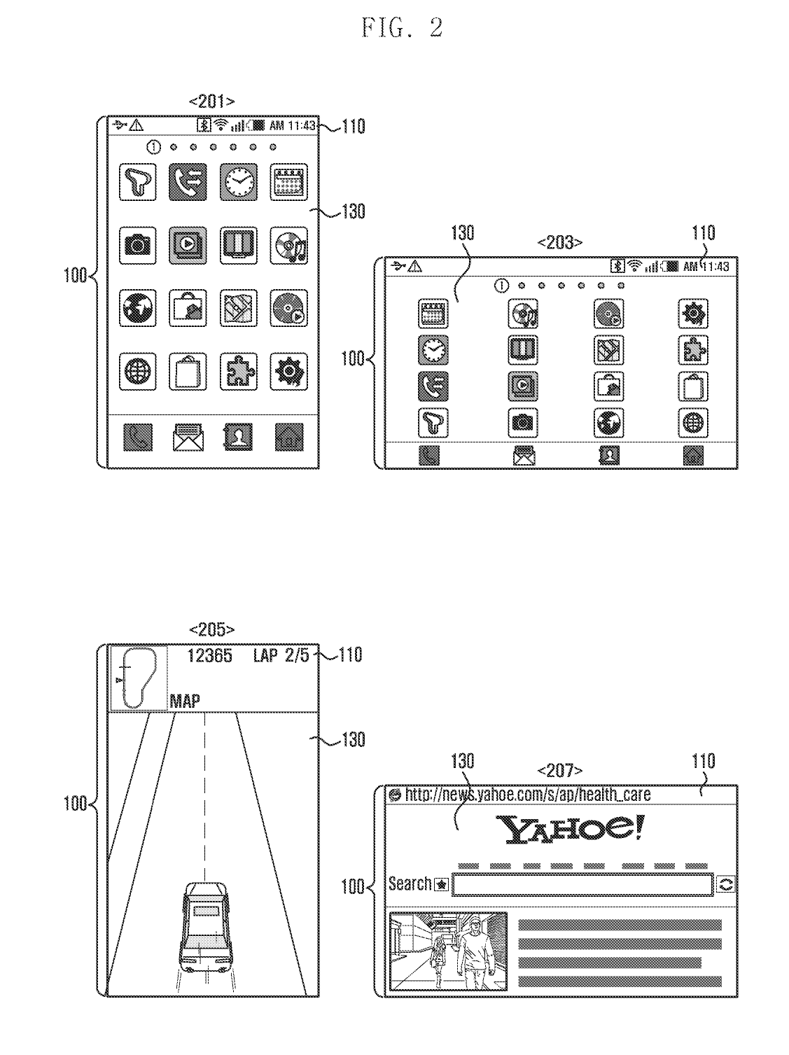

FIG. 2 is an example view illustrating various representations on a display unit of a touch-sensitive device according to an exemplary embodiment of the present invention.

Referring to FIG. 2, the display unit 100 separates a state information display region 110 for displaying state information about the touch-sensitive device and an execution information display region 130 for displaying an execution screen of a specific application.

The state information display region 110 receives a touch-based user gesture and thereby supports a screen brightness control function. The state information display region 110 may include an indicator region normally used in a mobile device as shown in examples 201 and 203, and another information region for displaying state information about a currently running application in the touch-sensitive device as shown in examples 205 and 207.

Examples 201 and 203 indicate that the state information display region 110 is displayed as the indicator region. An example 201 indicates that the touch-sensitive device operates in a lengthwise mode (i.e., a portrait mode), and another example 203 indicates that the touch-sensitive device operates in a widthwise mode (i.e., a landscape mode). In these examples, a predefined function (e.g., screen brightness) of the touch-sensitive device may be controlled in response to a touch-based user gesture input on the indicator region 110. Although an exemplary embodiment locates the state information display region 110 at the top of the display unit 100, other locations are of course possible without departing from the scope or spirit of the present invention.

When the display mode of the touch-sensitive device is changed from the lengthwise mode shown in the example 201 to the widthwise mode shown in the example 203, the brightness levels assigned to points on the indicator region 110 for a screen brightness adjustment may be adjusted accordingly. For instance, if the brightness level is assigned from level 1 to level 6 for one level in the example 201 (namely, level 1, level 2, . . . , level 6), the brightness level in the example 203 is assigned from level 1 to level 6 for half level (namely, level 1, level 1.5, level 2, . . . , level 5.5, level 6). This is because the size of the indicator region is greater in the widthwise mode than in the lengthwise mode. Therefore, a more detailed adjustment of the screen brightness is possible in the widthwise mode. However, in another exemplary embodiment, the brightness level might not change even though the display mode changes. In this case, a level interval is changed instead. In still another exemplary embodiment, the indicator region 110 may be fixed in position even though the display mode changes. For instance, in the example 203, the indicator region 110 may be disposed at the side of the display unit without changing its original position.

Examples 205 and 207 indicate that the state information display region 110 is displayed as another information region. An example 205 indicates that a selected application, such as a game application or a gallery application, is executed in the touch-sensitive device. In this example, a related execution screen 130 (e.g., a game screen, or a photo list screen) is displayed and further, at a part of the execution screen 130, state information associated with the selected application is displayed in an information region 110. Another example 207 indicates that when a web application is executed in the touch-sensitive device, a related execution screen 130 (e.g., a web page) is displayed and also state information (e.g., a web site address) is displayed in an information region 110. In these examples, a predefined function (e.g., screen brightness) of the touch-sensitive device may be controlled in response to a touch-based user gesture input on the information region 110. Therefore, a user can simply modify the screen brightness at any time without entering a setting mode while playing a game or performing a web surfing.

Of course, other predefined functions can be controlled this way. For example, an audio volume function might be controlled this way when execution a music player application.

Also, when an explorer having a tree structure is executed in the touch-sensitive device, the state information display region 110 may display steps of explorer routine (or path information).

A conventional touch-sensitive device displays only state information in the state information display region 110, and fails to support any input function through that region 110. An input function of a conventional device may be supported only in limited cases where the state information display region 110 is not displayed. Contrary to that, the touch-sensitive device of this invention allows the state information display region 110 to support a touch-based input function. In addition, this invention allows the adjustment of a selected function to be applied immediately to the touch-sensitive device while continuing to display an executing application when a user gesture is input on the state information display region 110.

For instance, when any touch-based user gesture is moved through a scroll action in a right or left direction on the state information display region 110, all screen brightnesses defined in the touch-sensitive device may be increased or decreased at once. Similarly, all the audio volume or all the vibration defined in the touch-sensitive device may be adjusted at once, depending on a user gesture scroll on the state information display region 110. A specific function to be adjusted through a user gesture input through the state information display region 110 may be predefined as default or may be selected by a user. An exemplary embodiment to be described hereinafter will adopt a case of the screen brightness as representative of such adjustable functions.

The state information display region 110 shown in FIG. 2 has a widthwise elongated form. However, this is exemplary only and not to be considered as a limitation of this invention. Alternatively, the state information display region 110 may have a lengthwise elongated form in which a user gesture may occur in up and down directions. Namely, a user gesture may be input in up and down directions or in right and left directions, depending on the elongated direction and location of the state information display region 110.

In addition, an exemplary embodiment to be described hereinafter will adopt the indicator region as the state information display region 110. Therefore, the state information display region 110 will be referred to as the indicator region, and the execution information display region 130 will be referred to as a normal display region. In this disclosure, the state information display region, the indicator region, the execution information display region, and the normal display region are terms for the sake of convenience and are not limiting.

The indicator region 110 may be allotted to a selected part (e.g., the upper part) of the display unit 100 in order to display necessary state information about the touch-sensitive device. The indicator region 110 may sometimes be omitted and replaced by the normal display region when a specific application is executed.

In an exemplary embodiment of this invention, state information might be represented as a certain item such as a static image or a dynamic image, and text in the indicator region 110 which may contain at least one state information item. For instance, state information item may include an item indicating signal strength, an item indicating the arrival of a message, an item indicating a state of vibration, sound, or mute, an item indicating a state of Bluetooth enabled or disabled, an item indicating a state of WiFi enabled or disabled, an item indicating a battery level, an item indicating a current time, and the like. The indicator region 110 may select and arrange one or more items among the above items according to environments in use of the touch-sensitive device. Any other items for indicating state information may be additionally used if necessary.

The indicator region in a conventional touch-sensitive device may be used only for a display function to display information about current environments of the touch-sensitive device through the above items. Such a conventional touch-sensitive device may require departing from a current execution screen and then entering a menu screen for setting the screen brightness in order to adjust the screen brightness. In addition, after adjusting the screen brightness, a conventional touch-sensitive device may further require closing the setting screen before invoking again an application.

However, as discussed above, an exemplary embodiment of this invention provides a function to adjust the screen brightness without interrupting a current screen display by using the indicator region 110. According to an exemplary embodiment of this invention, the indicator region 110 not only performs a display function, but also recognizes a touch-based user gesture. Therefore, the screen brightness may be adjusted in response to a touch-based user gesture (e.g., a leftward or rightward swing input) on the indicator region 110. A related description will be given below.

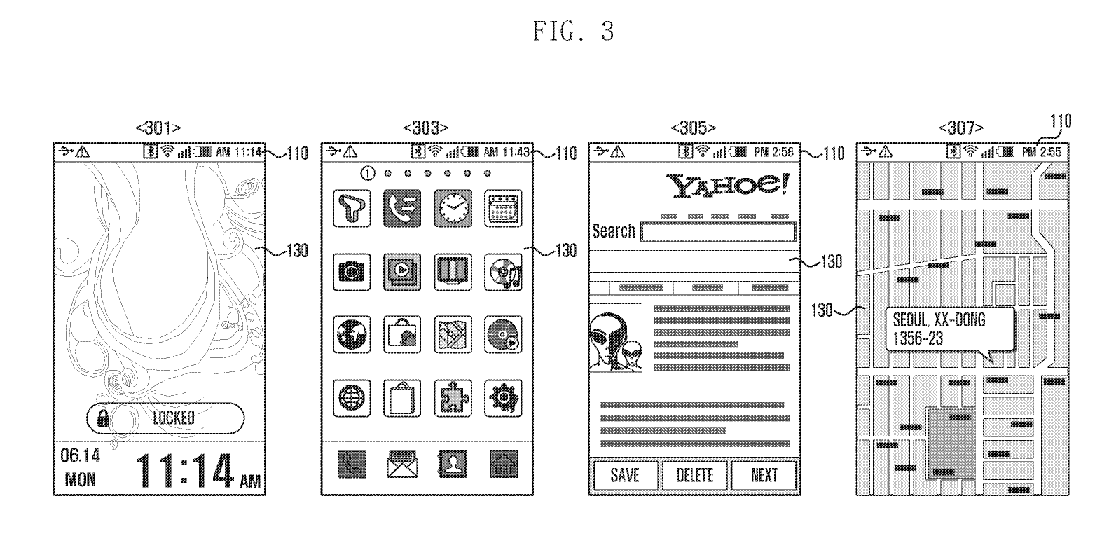

FIG. 3 is an example view illustrating various representations on a display unit of a touch-sensitive device according to exemplary embodiments of the present invention.

As shown in FIG. 3, in the touch-sensitive device, the execution screen is displayed through the normal display region 130, and the indicator region 110 is adjacent to the normal display region 130. Reference numbers 301, 303, 305 and 307 indicate various examples of representations on the display unit 100 in which the execution screen is displayed in the normal display region 130 except the indicator region 110. Specifically, reference number 301 indicates a locked state screen in which a touch-based input is not permitted. Reference number 303 indicates a main menu screen (also referred to as an idle state screen) in which many menu icons are arranged. Reference number 305 indicates a web application execution screen, and reference number 307 indicates a map application execution screen. Additionally, the indicator region 110 may be used in any other execution screens of various applications such as a message application, a communication application, a phonebook application, a diary application, a game application, and the like. The indicator region 110 may be omitted when a specific application uses the indicator region 110 as well as the normal display region 130 for its execution screen.

Referring to FIG. 3, the touch-sensitive device allows controlling the screen brightness through the indicator region 110 in the locked state screen 301. In this locked mode, a touch-based normal input on the normal display region 130 is not permitted, whereas a touch-based input on the indicator region 110 is permitted. Additionally, the touch-sensitive device allows controlling the screen brightness through the indicator region 110 in the main menu screen 303. Also, the touch-sensitive device allows controlling the screen brightness through the indicator region 110 in the web application execution screen 305 and the map application execution screen 307. Besides the above applications, the touch-sensitive device may allow controlling the screen brightness through the indicator region 110 in any environments, such as bright outdoors places or dark indoors places. A detailed description will be given below.

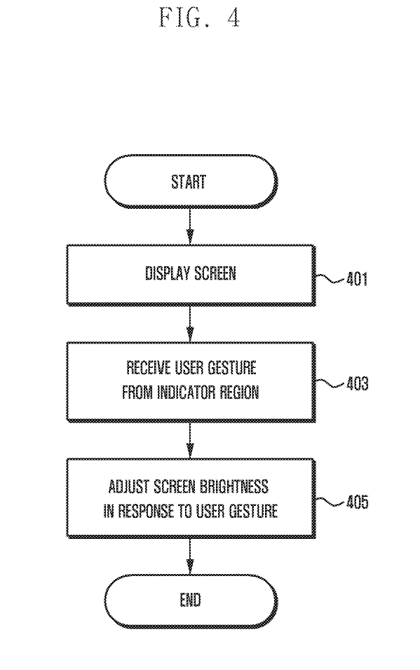

FIG. 4 is a flow diagram illustrating a method for controlling the screen brightness of a touch-sensitive device according to an exemplary embodiment of the present invention.

Referring to FIG. 4, the control unit 300 controls a display of a screen in step 401. For instance, the control unit 300 may control displaying various screens such as the locked state screen, the main menu screen, the message application execution screen, the communication application execution screen, the web application execution screen, the map application execution screen, the diary application execution screen, the phonebook application execution screen, and the like. Particularly, the control unit 300 may separately control a display of the indicator region 110 and a display of the normal display region 130.

Next, the control unit 300 may receive a user gesture input from the indicator region 110 in step 403. Specifically, if any touch-based user gesture occurs on the indicator region 110, the control unit 300 receives an input signal produced depending on a user gesture. In this disclosure, a user gesture may be input through various input types using a touch-based input interface. For instance, a user gesture may include an input to swing leftward or rightward after touching a certain point on the indicator region 110, an input to tap a certain point on the indicator region 110, an input to flick leftward or rightward after touching a certain point on the indicator region 110, and the like. Hereinafter, a swing input after a touch will be used as an exemplary user gesture.

Next, when receiving a user gesture input, the control unit 300 adjusts the screen brightness of the display unit 100 in response to a received user gesture in step 405. For instance, the control unit 300 may decrease the screen brightness in response to a leftward swing input after a touch on the indicator region 110. Similarly, the control unit 300 may increase the screen brightness in response to a rightward swing input after a touch on the indicator region 110. The decrease or increase of the screen brightness may be gradual.

Such a brightness control depending on a user input may be made within a predefined range of brightness level (e.g., from level 1 to level 6). For instance, a brightness level 1 may be defined as the lowest brightness level setting, of about 30˜32 cd, and a brightness level 6 may be defined as the highest brightness level setting, of about 196˜198 cd. The control unit 300 may control the screen brightness by increasing or decreasing the brightness level according to the moving direction and distance from an initial touch position of a user gesture. A range of the brightness level may be varied according to the type of the touch-sensitive device. The brightness levels 1 to 6 are exemplary only, and are not to be considered as a limitation of the present invention.

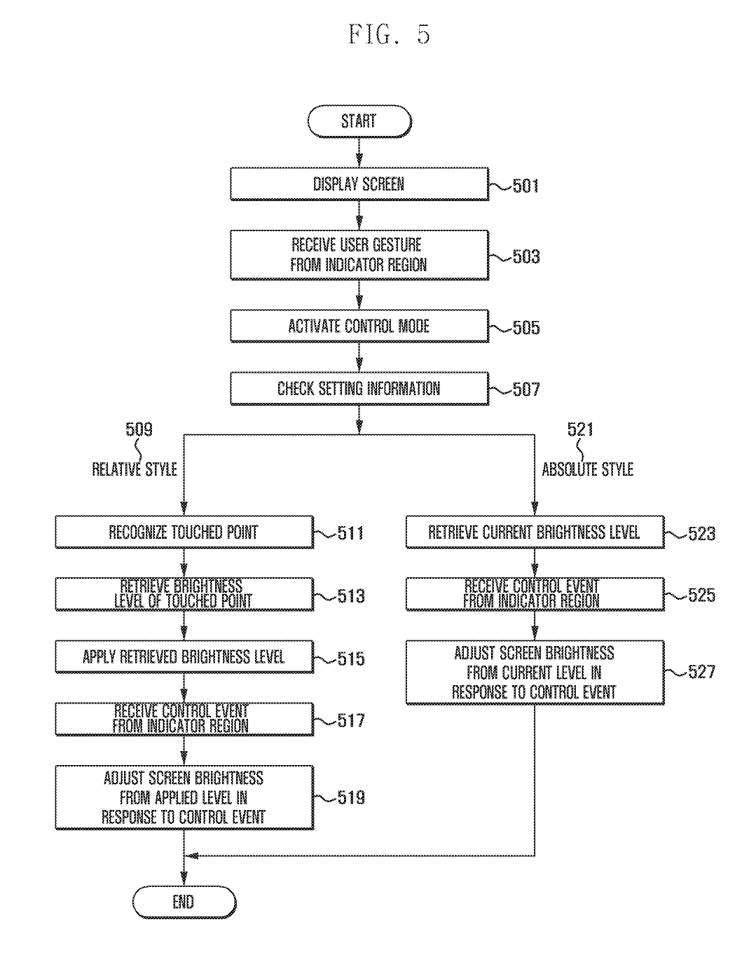

FIG. 5 is a flow diagram illustrating a method for controlling the screen brightness of a touch-sensitive device according to another exemplary embodiment of the present invention.

Referring to FIG. 5, at the outset, the control unit 300 controls a display of a screen in step 501. As discussed above, the control unit 300 may control displaying various screens in the display unit 100 that separates the indicator region 110 and the normal display region 130. Next, the control unit 300 may receive a user gesture input from the indicator region 110 in step 503. As discussed above, when any touch-based user gesture occurs on the indicator region 110, the control unit 300 receives an input signal produced depending on a user gesture.

Next, the control unit 300 activates a control mode for the control of the screen brightness through the indicator region 110 in step 505 and then checks setting information of the control mode in step 507. In this example, setting information refers to information about the style of adjustment for the screen brightness, such as a relative style and an absolute style. The relative style starts a brightness adjustment from a brightness level assigned to a touched point, whereas the absolute style starts a brightness adjustment from the currently defined brightness level regardless of the brightness level assigned to a touched point.

If the brightness adjustment style is determined to be set to the relative style in step 509, the control unit 300 recognizes a touched point on the indicator region in step 511 and retrieves the brightness level assigned to the touched point in step 513.

Next, the control unit 300 applies the retrieved brightness level of the touched point to the display unit 100 in step 515. Namely, the control unit 300 may adjust the current screen brightness in response to the brightness level of the touched point. For instance, if the brightness level of a current screen is 3 and that of the touched point is 5, the control unit 300 increases the screen brightness from level 3 to level 5 when receiving the initial touch input from that point of the indicator region 110.

In step 517, the control unit 300 receives a control event input based on a movement of the initial touch input from the indicator region 110. For instance, if a leftward or rightward swing input occurs on points of the indicator region 110 after the initial touch, the control unit 300 receives continuous input signals from the swing input points.

When receiving a control event input such as a swing input from the indicator region 110, the control unit 300 adjusts the screen brightness of the display unit 100 from the above-applied brightness level in response to a received control event in step 519. For instance, the control unit 300 may gradually decrease the screen brightness from the brightness level (e.g., level 5) of the touched point in response to a leftward swing input. In this case, if the control event reaches a point (e.g., a left boundary of the indicator region 110) of the lowest level by a leftward movement, the control unit 300 applies the screen brightness of the lowest level to the display unit 100. Thereafter, the control unit 300 may increase the screen brightness from the lowest level, depending on a rightward control event.

Similarly, the control unit 300 may gradually increase the screen brightness from the brightness level (e.g., level 5) of the touched point in response to a rightward swing input. In this case, if the control event reaches a point (e.g., a right boundary of the indicator region 110) of the highest level by a rightward movement, the control unit 300 applies the screen brightness of the highest level to the display unit 100. Thereafter, the control unit 300 may decrease the screen brightness from the highest level, depending on a leftward control event.

On the other hand, if the brightness adjustment style is determined to be set to the absolute style in step 521, the control unit 300 retrieves the current brightness level in step 523. Namely, the control unit 300 may retrieve the brightness level defined as the current screen brightness of the display unit 100 when receiving an initial touch input from the indicator region 110.

Next, the control unit 300 receives a control event input based on a movement of an initial touch input from the indicator region 110 in step 525. For instance, if a leftward or rightward swing input occurs on points of the indicator region 110 after an initial touch, the control unit 300 receives continuous input signals from the swing input points.

When receiving a control event input such as a swing input from the indicator region 110, the control unit 300 adjusts the screen brightness of the display unit 100 from the current brightness level in response to a received control event in step 527. For instance, the control unit 300 may gradually decrease the screen brightness from the current brightness level in response to a leftward swing input. In this case, if the control event reaches a point (e.g., a left boundary of the indicator region 110) of the lowest level by a leftward movement, the control unit 300 applies the screen brightness of the lowest level to the display unit 100. Thereafter, the control unit 300 may increase the screen brightness from the lowest level, depending on a rightward control event.

Similarly, the control unit 300 may gradually increase the screen brightness from the current brightness level in response to a rightward swing input. In this case, if the control event reaches a point (e.g., a right boundary of the indicator region 110) of the highest level by a rightward movement, the control unit 300 applies the screen brightness of the highest level to the display unit 100. Thereafter, the control unit 300 may decrease the screen brightness from the highest level, depending on a leftward control event.

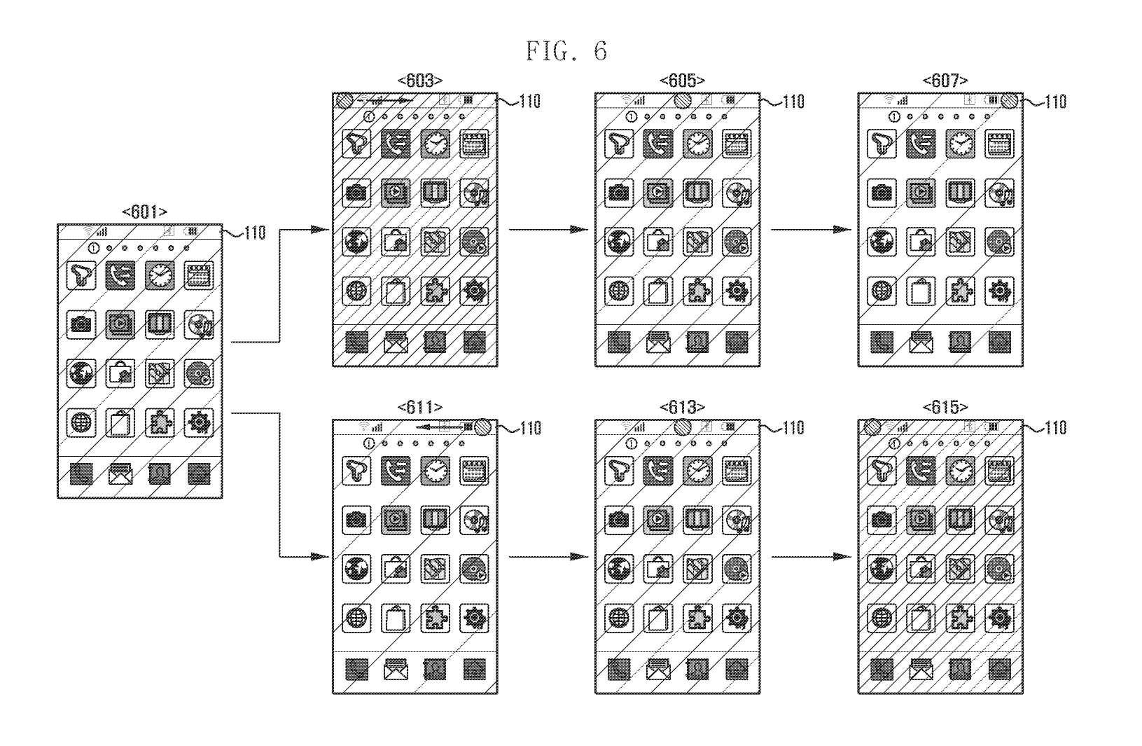

FIG. 6 is an example view illustrating a process of controlling the screen brightness through an indicator region of a touch-sensitive device according to an exemplary embodiment of the present invention.

FIG. 6 shows a process of adjusting the screen brightness in response to a touch-based user gesture on the indicator region 110 at the main menu screen in which many menu icons for executing respective applications are arranged. In drawings, degree of the screen brightness is expressed as density of hatching lines. A high density of hatching lines indicates a low brightness level (dark), and a low density of hatching lines indicates a high brightness level (bright). In addition, FIG. 6 adopts the above-described relative style as the brightness adjustment style.

Referring to FIG. 6, reference number 601 indicates an initial stage of the main menu screen in the display unit 100 that separates the indicator region 110 and the normal display region 130. It is supposed in this example that the initial stage 601 of the main menu screen has the screen brightness of level 3. In this initial stage 601, a user can input a given touch-based gesture on the indicator region 110. For instance, in order to increase the screen brightness, a user may touch a certain point (e.g., a point near a left boundary) of the indicator region 110 as shown in a next stage 603.

Then the control unit 300 receives a touch input on a specific point from the indicator region 110, retrieves the brightness level assigned to the touched point, and applies the retrieved brightness level to the current screen brightness. For instance, if the current brightness level is 3 and the brightness level of a touched point is 1, the control unit 300 decreases the screen brightness from level 3 to level 1. Therefore, the screen brightness becomes darker as shown in the stage 603 in comparison with the initial stage 601.

After a touch gesture input as shown in the stage 603, a user can continuously input a control event (e.g., a swing input) for moving the touch input in a right direction in order to increase the screen brightness as shown in next stages 605 and 607. Then the control unit 300 receives an input of a rightward control event and gradually increases the brightness level in response to a received control event. For instance, according as a control event is ongoing as shown in the stages 605 and 607, the control unit 300 gradually increases the brightness level from level 1, namely from the brightness level of the initial touched point. Therefore, the screen brightness becomes brighter. If a rightward control event is changed to a leftward control event in any stage such as 605 or 607, the brightness level may begin to decrease accordingly in response to the leftward control event.

On the other hand, in the initial stage 601, a user can touch another point (e.g., a point near a right boundary) of the indicator region 110, as shown in a stage 611. Then the control unit 300 receives a touch input on a specific point from the indicator region 110, retrieves the brightness level assigned to the touched point, and applies the retrieved brightness level to the current screen brightness. For instance, if the current brightness level is 3 and the brightness level of a touched point is 6, the control unit 300 increases the screen brightness from level 3 to level 6. Therefore, the screen brightness becomes brighter as shown in the stage 611 in comparison with the initial stage 601.

After a touch gesture input as shown in the stage 611, a user can continuously input a control event (e.g., a swing input) for moving the touch input in a left direction in order to decrease the screen brightness, as shown in next stages 613 and 615. Then the control unit 300 receives an input of a leftward control event and gradually decreases the brightness level in response to a received control event. For instance, if a control event is ongoing as shown in the stages 613 and 615, the control unit 300 gradually decreases the brightness level from level 6, namely from the brightness level of the initial touched point. Therefore, the screen brightness becomes darker. If a leftward control event is changed to a rightward control event in any stage such as 613 or 615, the brightness level may begin to increase accordingly in response to the rightward control event.

The above-discussed example in FIG. 6 is a case where the initial touch input starts from a point near a left or right boundary of the indicator region 110, and thereby the brightness level is initially changed to the lowest or highest level. However, this is exemplary only and not to be considered as a limitation of this invention. The initial touch input may start from any arbitrary point of the indicator region 110, and hence the screen brightness may be adjusted depending on the brightness level assigned to the initially touched point.

Additionally, in a case of adopting the relative style like the example of FIG. 6, the screen brightness may be adjusted through a tap input on the indicator region 110. Namely, when a tap input occurs on any selected point of the indicator region 110, the control unit 300 may retrieve the brightness level assigned to the tap point and then apply the retrieved brightness level to the current screen brightness.

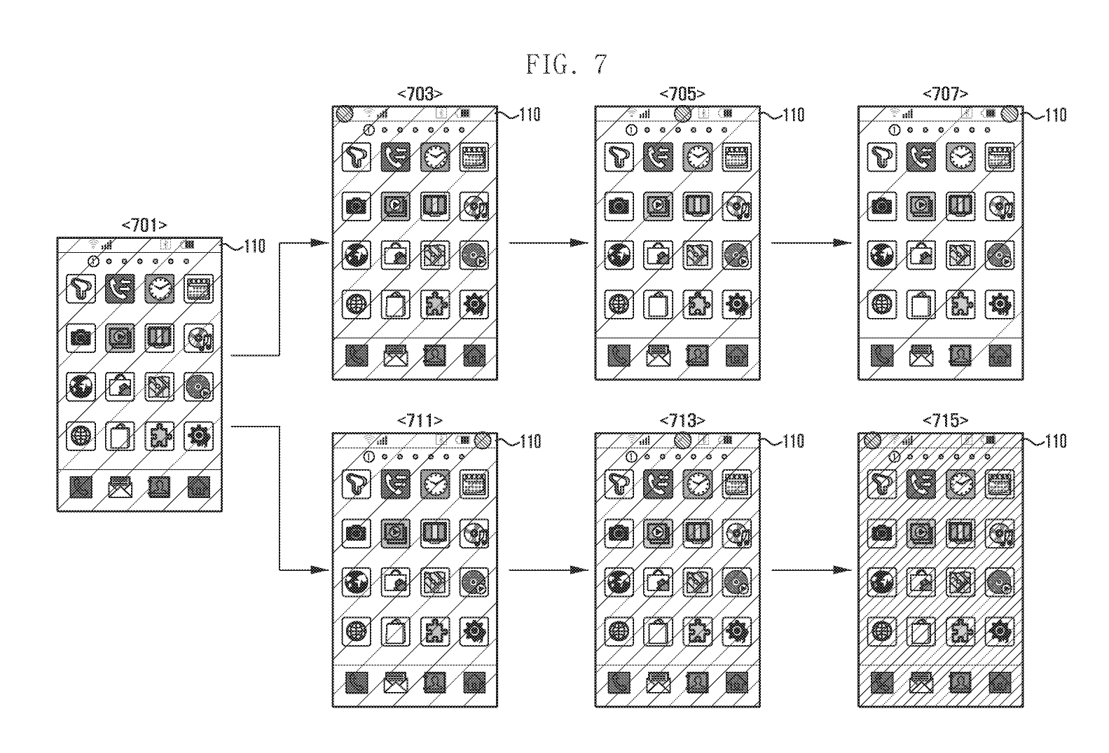

FIG. 7 is an example view illustrating a process of controlling the screen brightness through an indicator region of a touch-sensitive device according to an exemplary embodiment of the present invention.

FIG. 7 shows a process of adjusting the screen brightness in response to a touch-based user gesture on the indicator region 110 at the main menu screen in which many menu icons for executing respective applications are arranged. In these drawings, the degree of the screen brightness is expressed as density of hatching lines. A high density of hatching lines indicates a low brightness level (dark), and a low density of hatching lines indicates a high brightness level (bright). Particularly, the exemplary embodiment depicted in FIG. 7 adopts the absolute style as the brightness adjustment style.

Referring to FIG. 7, reference number 701 indicates an initial stage of the main menu screen in the display unit 100 that separates the indicator region 110 and the normal display region 130. It is supposed in this example that the initial stage 701 of the main menu screen has a screen brightness of level 3. In this initial stage 701, a user can input a given touch-based gesture on the indicator region 110. For instance, in order to increase the screen brightness, a user may touch a certain point (e.g., a point near a left boundary) of the indicator region 110 as shown in a next stage 703.

Then the control unit 300 retrieves the brightness level defined as the current screen brightness of the display unit 100. At this time, the screen brightness is not yet changed as shown in stages 701 and 703.

After a touch gesture input as shown in the stage 703, a user can continuously input a control event (e.g., a swing input) for moving the touch input in a rightward direction in order to increase the screen brightness as shown in next stages 705 and 707. Then the control unit 300 receives an input of a rightward control event and gradually increases the brightness level in response to a received control event. For instance, if a control event is ongoing as shown in the stages 705 and 707, the control unit 300 gradually increases the brightness level from level 3, namely from the level of the current screen brightness. Therefore, the screen brightness becomes brighter. If a rightward control event is changed to a leftward control event in any stage such as 705 or 707, the brightness level may begin to decrease accordingly in response to the leftward control event.

On the other hand, in the initial stage 701, a user can touch another point (e.g., a point near a right boundary) of the indicator region 110 as shown in a stage 711. Then the control unit 300 retrieves the brightness level defined as the current screen brightness of the display unit 100. At this time, the screen brightness is not yet changed as shown in stages 701 and 711.

After a touch gesture input as shown in the stage 711, a user can continuously input a control event (e.g., a swing input) for moving the touch input in a leftward direction in order to decrease the screen brightness as shown in next stages 713 and 715. Then the control unit 300 receives an input of a leftward control event and gradually decreases the brightness level in response to a received control event. For instance, according as a control event is ongoing as shown in the stages 713 and 715, the control unit 300 gradually decreases the brightness level from level 3, namely from the level of the current screen brightness. Therefore, the screen brightness becomes darker. If a leftward control event is changed to a rightward control event in any stage such as 713 or 715, the brightness level may begin to increase accordingly in response to the rightward control event.

The above-discussed example in FIG. 7 is case where the initial touch input starts from a point near a left or right boundary of the indicator region 110. However, this is exemplary only and not to be considered as a limitation of this invention. Alternatively, the initial touch input may start from any arbitrary point of the indicator region 110.

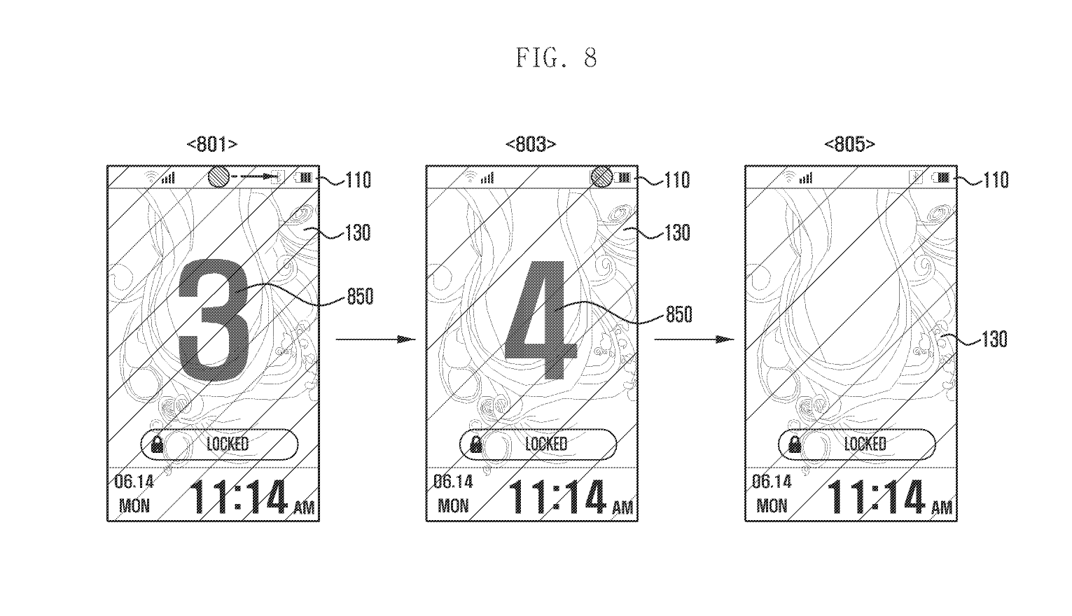

FIGS. 8 to 11 are example views illustrating a process of controlling the screen brightness through an indicator region of a touch-sensitive device according to exemplary embodiments of the present invention.

As shown in FIGS. 8 to 11, while the screen brightness is controlled in response to a user gesture, level information about the current brightness level may also be displayed by means of a graphical user interface (GUI) using a static image, a dynamic image, text, numbers, etc.

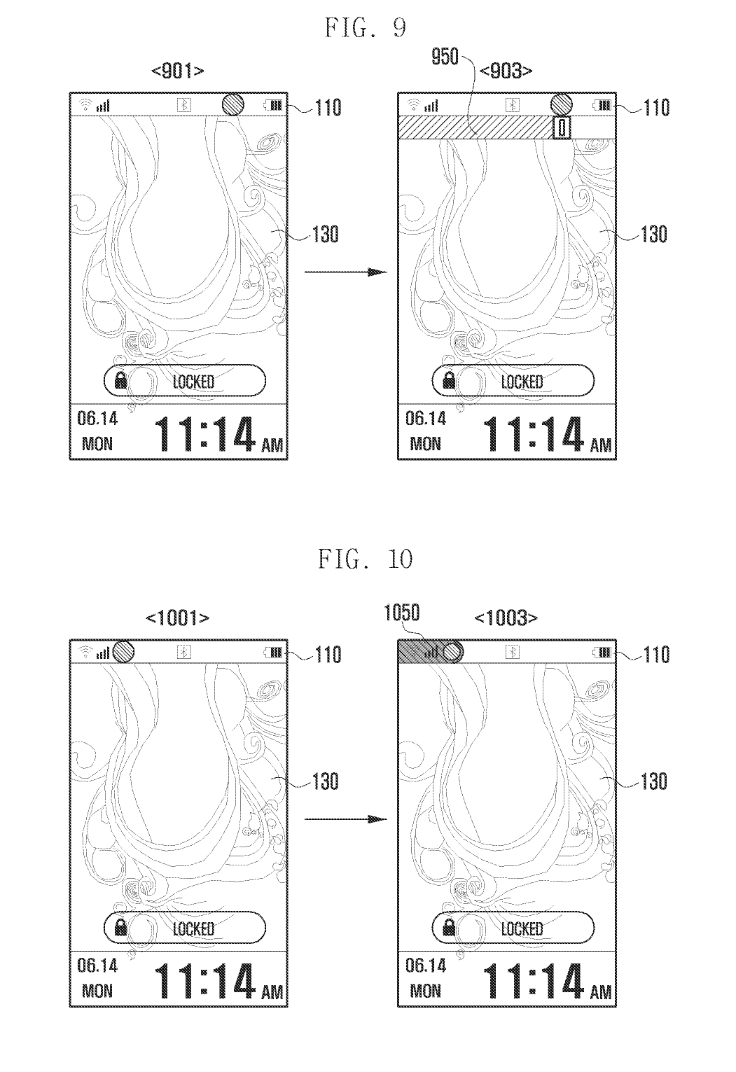

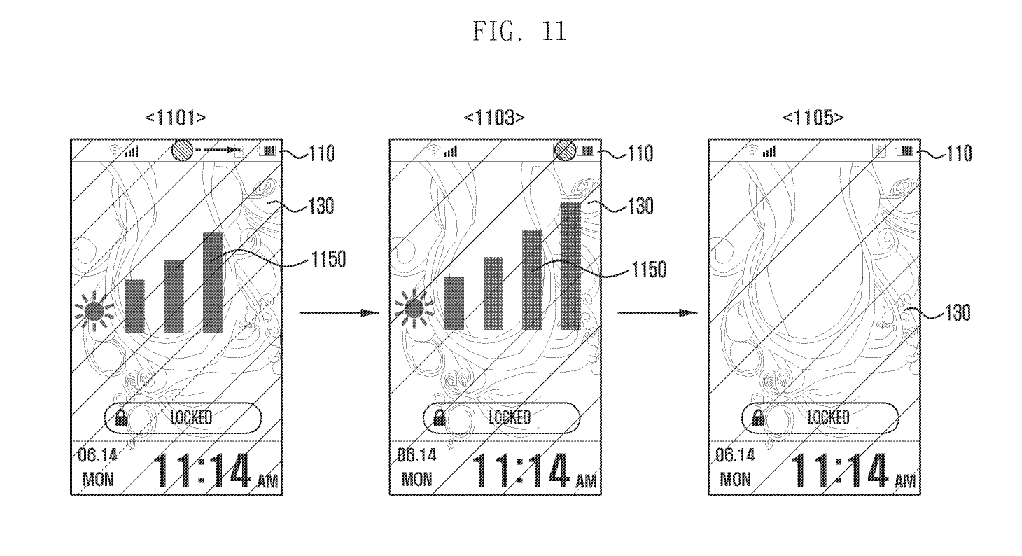

Specifically, FIG. 8 shows an example in which brightness level information is displayed by means of numbers 850 when the screen brightness is adjusted through the indicator region 110. FIG. 9 shows another example in which brightness level information is displayed by means of a slider 950 when the screen brightness is adjusted through the indicator region 110. FIG. 10 shows an example in which brightness level information is displayed by means of a shadow-like trace 1050 when the screen brightness is adjusted through the indicator region 110. FIG. 11 shows an example in which brightness level information is displayed by means of a certain graphic image 1150 when the screen brightness is adjusted through the indicator region 110. These examples are exemplary only and any other various techniques may be used to display such level information. Although in the above examples the level information is displayed in only one of the indicator region 110 and the normal display region 130, such level information may be displayed in both of the indicator region 110 and the normal display region 130, in the form of any combination of the above examples.

Referring to FIG. 8, as shown in stages 801 and 803, information about the brightness level corresponding to a user gesture may be expressed by means of numbers 850 in the normal display region 130. As shown in the stage 801, if the brightness level according to the current user gesture is the level 3 for example, the number 3 is represented as level information 850 in the normal display region 130. Thereafter, as shown in the stage 803, if the user gesture is moved rightward to increase the screen brightness, the brightness level is changed to the level 4 for example and therefore the number 4 is represented as level information 850 in the normal display region 130. These numbers used as level information 850 may be displayed in overlay form on the execution screen in the normal display region 130. As shown in stage 805, if a touch-based user gesture is released from the indicator region 110, the above-described level information 850 may disappear from the normal display region 130.

Referring to FIG. 9, when a touch-based user gesture is input on the indicator region 110 as shown in stage 901, a slider 950 may appear in the normal display region 130 as shown in stage 903. This slider 950 indicates information about the brightness level corresponding to the user gesture. The slider 950 may be located near the indicator region 110. In addition, the slider 950 may resemble a typical scroll bar, and also a passed track of the slider 950 may be visually distinguished. The slider 950 may be displayed in overlay form on the execution screen in the normal display region 130. If a touch-based user gesture is released from the indicator region 110, the slider 950 may disappear from the normal display region 130.

Referring to FIG. 10, when a touch-based user gesture is input on the indicator region 110 as shown in stage 1001, a shadow-like trace 1050 may appear in the indicator region 110 as shown in stage 1003. The shadow-like trace 1050 indicates information about the brightness level corresponding to the user gesture. Contrary to the slider 950 in FIG. 9, the shadow-like trace 1050 may be located within the indicator region 110. Like the slider 950 in FIG. 9, the shadow-like trace 1050 may have a visual representation that varies depending on the position of the user gesture. In addition, the shadow-like trace 1050 may be displayed in overlay form on the indicator region 110. If a touch-based user gesture is released from the indicator region 110, the shadow-like trace 1050 may disappear from the indicator region 110.

Referring to FIG. 11, when a touch-based user gesture is input on the indicator region 110 as shown in stage 1101, a certain graphic image 1150 may appear in the normal display region 130 as shown in stage 1103. For instance, if the brightness level according to a user gesture is level 3 as shown in the stage 1101, the graphic image 1150 may be expressed as three graphic bars in the normal display region 130. Thereafter, if the user gesture is moved rightward to increase the screen brightness as shown in the stage 1103, the brightness level is changed to the level 4 for example and therefore the graphic image 1150 is expressed as four graphic bars in the normal display region 130. The graphic image 1150 may be displayed in overlay form on the execution screen in the normal display region 130. If a touch-based user gesture is released from the indicator region 110, the graphic image 1150 may disappear from the normal display region 130. In addition, the graphic image 1150 may include any other specific graphic, such as the sun or a headlight, to indicate that the current function is to adjust the screen brightness. Similarly, other icons can be displayed accordingly to indicate this or other functions. For example, a speaker icon may be included if the current function is to adjust audio volume.

As fully discussed hereinbefore, the touch-sensitive device and related control method according to this invention enable a simple and quick adjustment of a function such as the screen brightness of the display unit in response to a touch-based user gesture on the state information display region. This invention may be applied to any device having a touch-based input interface and a state information display region such as the indicator region.

According to an exemplary embodiment of the present invention, the screen brightness can be quickly adjusted through a simple user gesture input on the state information display region without interrupting a current execution screen displayed in the display unit. Therefore, a process of adjusting the screen brightness in the touch-sensitive device becomes much simpler, and hence the touch-sensitive device provides a more optimal environment for an adjustment of the screen brightness. In addition, this invention provides various ways of adjusting the screen brightness through the state information display region in order to meet various user's demands or usage patterns. Also, by realizing a simpler and more intuitive interface for an adjustment of the screen brightness, this invention improves usability, convenience, and competitiveness of the touch-sensitive device.

Certain aspects of the present invention can also be embodied in hardware or as software or computer readable code stored in a recording medium such as a CD ROM, a RAM, a floppy disk, a hard disk, or a magneto-optical disk, or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Also, functional programs, code, and code segments for accomplishing the present invention can be easily construed by programmers skilled in the art to which the present invention pertains.

While this invention has been shown and described with reference to certain exemplary embodiment thereof, it will be understood by those skilled in the art that various changes in form and details may be made therein without departing from the spirit and scope of the invention as defined by the appended claims and their equivalents.

What is claimed is:

1. A method for controlling a screen brightness of a touch-sensitive device, the method comprising:
displaying a screen comprising a state information display region and a normal display region;
receiving a touch-based user gesture in the state information display region; and
adjusting the screen brightness in response to the received user gesture.

2. The method of claim 1, wherein the adjusting of the screen brightness includes increasing or decreasing the screen brightness in response to the received user gesture input on the state information display region without interrupting an execution screen displayed in the normal display region.

3. The method of claim 2, wherein the adjusting of the screen brightness includes:
increasing the screen brightness in response to a moving in a first predetermined direction of the user gesture in the state information display region; and
decreasing the screen brightness in response to a moving in a direction opposite the first predetermined direction of the user gesture in the state information display region.

4. The method of claim 2, further comprising:
checking setting information in a control mode for adjusting the screen brightness when receiving the user gesture and adjusting the screen brightness in accordance with the setting information.

5. The method of claim 4, wherein the setting information includes information about an adjustment style of adjusting the screen brightness through the state information display region,
the adjustment style comprising one of a relative style and an absolute style,
the relative style starting a brightness adjustment from a brightness level assigned to a touched point on which the user gesture is input, and
the absolute style starting the brightness adjustment from a currently defined brightness level regardless of the touched point.

6. The method of claim 5, wherein the adjusting of the screen brightness includes:
if the adjustment style is set to the relative style, retrieving a brightness level assigned to the touched point;
adjusting the screen brightness using the retrieved brightness level of the touched point; and
further adjusting the screen brightness from the retrieved brightness level in response to a moving of the user gesture.

7. The method of claim 6, further comprising:
if the adjustment style is set to the relative style, receiving a tap input from the state information display region;
retrieving a brightness level assigned to a location of the tap in the state information display region; and
adjusting the screen brightness using the retrieved brightness level of the location of the tap.

8. The method of claim 5, wherein the adjusting of the screen brightness includes:
if the adjustment style is set to the absolute style, retrieving a brightness level defined as a current screen brightness; and
adjusting the screen brightness from the retrieved brightness level in response to a moving of the user gesture.

9. The method of claim 2, further comprising:
when receiving an input of the user gesture, visually displaying brightness level information about the screen brightness depending on the user gesture input.

10. The method of claim 9, wherein the displaying of the brightness level information includes displaying the brightness level information in at least one of the state information display region and the normal display region.

11. The method of claim 9, further comprising:
when a brightness level is changed depending on a movement of the user gesture, displaying new brightness level information modified depending on the changed brightness level.

12. The method of claim 9, wherein the brightness level information comprises an alphanumeric character corresponding to the brightness level.

13. The method of claim 9, wherein the brightness level information comprises a language-independent graphical display corresponding to the brightness level.

14. The method of claim 9, wherein the brightness level information disappears from the display when the touch-based user gesture is released.

15. A touch-sensitive device, the device comprising:
a display unit configured to display a screen including a state information display region and to receive a touch-based user gesture scrolled along the state information display region; and
a control unit configured to receive the user gesture from the display unit and to adjust a screen brightness of the display unit in response to the received user gesture.

16. The device of claim 15, wherein the state information display region is an indicator region or an information region indicating state information according to environments in use of the device.

17. The device of claim 15, wherein the display unit is further configured to offer a normal display region for displaying an execution screen, the normal display region being adjacent to the state information display region, and to display brightness level information about the screen brightness depending on the user gesture input in at least one of the state information display region and the normal display region.

18. The device of claim 15, further comprising:
a memory unit configured to store setting information about an adjustment style of the screen brightness through the state information display region.

19. The device of claim 18, wherein the adjustment style comprises one of a relative style and an absolute style, the relative style starting a brightness adjustment from a brightness level assigned to a touched point on which the user gesture is input, and the absolute style starting the brightness adjustment from a currently defined brightness level regardless of the touched point.

20. A method for controlling a predetermined function of a touch-sensitive device, the method comprising:
displaying a screen comprising a state information display region;
receiving a touch-based user gesture in the state information display region; and
adjusting the particular function in response to the received user gesture.

21. The method of claim 20, wherein the adjusting of the predetermined function includes increasing or decreasing at least a selected one function of a screen brightness, an audio volume, and a vibration, which are capable of being applied immediately to the device.

22. The method of claim 20, wherein the receiving and adjusting occur without interrupting an execution screen displayed in a normal display region.
